(19) United States
(12) Patent Application Publication
(10) Pub. No.: US 2026/0264929 A1
(43) Pub. Date: Sep. 10, 2026

(54) COMPOSITE FILM FOR SEALABLE AND PEELABLE LIDDING TO BE SEALED AGAINST PLAIN TINPLATE

(71) Applicant: Amcor Flexibles North America, Inc., Neenah, WI (US)

(72) Inventor: Christoph Dietrich, Singen (DE)

(21) Appl. No.: 19/491,307

(22) PCT Filed: Jun. 21, 2023
(86) PCT No.: PCT/US2023/025870

§ 371 Date: Dec. 8, 2025

(51) Int. Cl. B65D 17/50; B32B 7/06; B32B 7/12; B32B 15/085; B32B 27/08; B32B 27/20; B32B 27/32

(52) U.S. Cl. CPC B65D 17/502; B32B 7/06; B32B 7/12; B32B 15/085; B32B 27/08; B32B 27/20; B32B 27/32; B32B 2255/06; B32B 2264/10; B32B 2270/00; B32B 2307/748; B32B 2581/00; B65D 2517/5067

(57) ABSTRACT

A composite film for closing a container by sealing the composite film against a tinplate sealing surface of the container or of a tinplate cap ring to be connected to the container. The composite film comprising a metal layer, a peel layer, a tie layer, and a seal layer connected to the metal layer. The peel layer, tie layer, and seal layer are coextruded with the peel layer being a cohesively breaking intermediate layer. The composite film is suitable for tight sealing against sealing surfaces made of tinplate that has a plain surface or a surface that has been subjected to a passivation or lubrification treatment.

### TECHNICAL FIELD

An improved composite film comprising a support layer made of a metal layer and a sealing layer connected to the metal layer for closing a container by sealing the composite film against a sealing surface of the container or of a cap ring to be connected to the container. More particularly, the disclosure provides a container or a cap ring for connecting to a container having a sealing surface made of tinplate, with a closing membrane made of the composite film which is sealed onto the sealing surface and can be peeled from the sealing surface.

### BACKGROUND

Closing membranes made of a composite film comprising a support layer made of an aluminum film or foil and a sealing layer connected to the aluminum film or foil for closing a container by sealing the composite film against a sealing surface of the container or of a cap ring to be connected to the container are known. Generally, these closing membranes provide a more user-friendly and safe opening when compared to a metal based top or lid.

For the secure closing of containers made of tinplate or of containers having a cap ring made of tinplate, a closing membrane is typically heat sealed to a circumferential sealing surface having a heat sealable coating. This heat sealable coating is provided to ensure that adhesion of the closing membrane is resistant to temperature and pressure fluctuation within the interior of the container. Although the process of heat sealing is a generally effective method for activating a heat sealable coating, the temperatures required for this sealing, referred to as the seal initiation temperature (“SIT”), are often desired to be lowered. A lower SIT is desired to provide an efficient packaging process and ensure that products within the container to be sealed are not subject to unnecessary heat resulting in potential degradation or premature expiration.

US Pat. Appl. Publ. No. 2006/0141241 to Carespodi et al. discloses a composite peel away structure for use in packaging that discloses peelable multi-layered structures including a breakaway layer that functions by cohesive failure. The breakaway layer of Carespodi et al. is a first matrix of a first polymer into which a second polymer is blended, with the first polymer and the second polymer being Incompatible polymers and including an inert filler. The incompatible polymers are selected with one polymer being a linear polyolefin and the second being a branched-chain polyolefin. For use in sealing to metal, Carespodi et al. suggests a breakaway layer comprising a linear polyolefin or a branched polyolefin with an acid functionality, such as acrylic acid, methacrylic acid, or maleic acid anhydride. Despite this suggestion, the structure of Carespodi et al. lacks sufficient support for a breakaway structure that provides lower seal initiation temperatures when compared to traditional structures along with extrudability, sealability, peelability, and comprised of materials that are compliant with food contact material regulations.

### SUMMARY

The basic object of the present disclosure is to create a composite film suitable as a closing membrane for a container or a cap ring to be connected to a container, which makes possible a robust seal against both uncoated metal sealing surfaces, in particular sealing surfaces comprising tinplate or aluminum, as well as against heat-scalable, modified sealing surfaces. Another object of the present disclosure is the simultaneous providing of an easily recognizable tamper-proof seal in the form of a “footprint” being a white trace indicating a successful seal. Further, it is an object of the present disclosure to provide a composite film that is capable of having a lower seal initiation temperature (SIT) when compared to traditional and known high barrier solutions.

The composite film for sealable and peelable lidding to be sealed against tinplate includes at least a metal layer, a peel layer being a breaking intermediate layer, a seal layer, and a tie layer. The peel layer comprising a blend of two polyolefinic polymers having branched chains and an inert filler, such as, but not limited to talc. The seal layer comprises a linear low density polyethylene (LLDPE) graft with maleic acid anhydride (MAH) blended with at least low density polyethylene (LDPE). In an assembly of the composite film, the tie layer, peel layer, and seal layer are provided through a coextrusion and are adhered to the metal layer to form the final composite film structure for use in sealable and peelable lidding.

### BRIEF DESCRIPTION OF THE DRAWINGS

The disclosure may be more completely understood in consideration of the following detailed description of various embodiments of the disclosure in connection with the accompanying drawings, in which:

FIG. 1 is a cross-sectional view of a composite film for use in sealable and peelable lidding for sealing against plain tinplate;

FIG. 2 shows a section through a cap ring with closing membrane formed from a punch out of the composite film;

FIG. 3 shows a section though an opening area of a container with the closing membrane sealed on the outside of the container;

FIG. 4 shows a section through an opening area of a container with the closing membrane sealed on the inside of the container.

The drawings show some but not all embodiments. The elements depicted in the drawings are illustrative and not necessarily to scale, and the same (or similar) reference numbers denote the same (or similar) features throughout the drawings.

### DETAILED DESCRIPTION

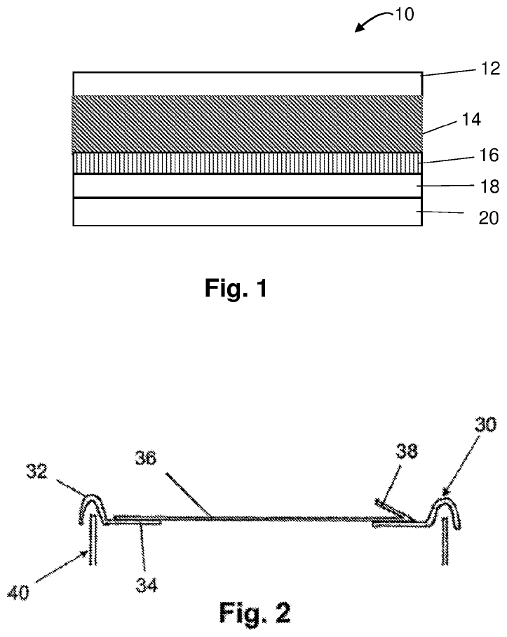

Referring now to FIGS. 1-4 of a composite film for sealable and peelable lidding to be sealed against plain tinplate and associated containers utilizing a closing membrane formed from the composite film and referred to herein as composite film 10. The composite film 10 is generally a multilayered film comprising a protective coating layer 12, a metal layer 14, a tie layer 16, a peel layer 18, and a seal layer 20 with the tie layer 16, peel layer 18, and seal layer 20 being an extrusion coating to be sealed against tinplate. Tinplate being a thin, cold-rolled steel plate, whose surface is coated with tin. The tin coating is used, above all, for protection against corrosion. The tin layer of tinplate would—were it to remain unprotected—further oxidize due to the oxygen content of the air potentially impacting good coating adhesion. Therefore, tinplate is usually subjected to a passivation treatment after the tinplating, by chromium and chromium oxide being applied on each side for improving the corrosion resistance. Moreover, the painting and printing properties are consequently improved. As tinplate passivation methods, the following methods are usually used (see also DIN standard EN 10202):
1. Code 300: Dip treatment in a chemical solution of a dichromate salt, wherein the chromium application per surface unit is 1.0 mg/m² to 3.0mg/m².
2. Code 311: Cathodic treatment in a dichromate salt solution of an alkali metal, wherein the chromium application per surface unit is 3.5 mg/m² to 9.0 mg/m².
3. Code 314: Electrochemical passivation, wherein the chromium application per surface unit is 5 mg/m² to 9.0 mg/m².

A preferred tinplate is provided with a dip passivation (code 300), a cathodic passivation (code 311) or with an electrochemical passivation (code 314).

Alternately, the polished tinplate may have a chromium free passivation or may have undergone a lubrification process. Typical lubrification is comprised of lubricating the tinplate surface with dioctyl sebacate (DOS). The materials selected for the composite film 10 do not hinder bonding upon the surface of the tinplate when the tinplate has been subjected to passivation and lubrification.

The term “layer”, as used herein, refers to a building block of a film or laminate that is a structure of a single material type, a homogeneous blend of materials or a dispersion blend of materials. A layer may be a single polymer, a blend of materials within a single polymer type or a blend of various polymers, may contain metallic materials, such as a metal foil, and may have additives. Layers may be continuous with the film (i.e., coextensive with the film) or may be discontinuous or patterned. A layer has an insignificant thickness (z direction) as compared to the length and width (x-y direction), and therefore is defined to have two major surfaces, the area of which are defined by the length and width of the layer. An exterior layer is one that is connected to another layer at only one of the major layer surfaces. In other words, one major surface of an exterior layer is exposed. An intermediate layer is one that is connected to another layer at both major surfaces. In other words, an intermediate layer is between two other layers. A layer may have sub-layers.

Similarly, the term “film”, as used herein, refers to a web built of layers and/or films, all of which are directly adjacent to and connected to each other. A film can be described as having a thickness that is insignificant as compared to the length and width of the film. Films are generally regarded as having two major surfaces, opposite each other, expanding in the length and width directions. As used herein, a “laminate” is a film that may be built from an unlimited number of films and/or layers, the films and/or layers being bonded together by any known process such as, but not limited to, coextrusion, coating or laminating, to form a composite article.

The peel layer 18 being an intermediate layer. The peel layer 18 may comprise one or more layers. The peel layer 18 is comprised of a linear low density polyethene (LLDPE) combined with low density polyethylene (LDPE) and a dispersed inert filler, preferably talc. As used herein the preferred LLDPE for peel layer 18 is Elite™ 5811 enhanced polyethylene resin provided by Dow Chemical Company. As used herein the preferred LDPE for use in peel layer 18 is Dow™ LDPE PG7008 low density polyethylene resin provided by Dow Chemical Company. As used herein the preferred dispersed inert filler for use in peel layer 18 is Finntalc M05SL functional extender provided by Elementis Specialties, Inc. This LLDPE/LDPE and dispersed talc formulated peel layer 18 provides acceptable peel values when tested. The peel layer 18 comprising up to about 20% by weight of dispersed inert filler, such as talc, of about 50% to 60% by weight of LLDPE, and of about 20% to 30% by weight of LDPE. Critical to the performance of the peel layer 18 is the ratio of linear low density to low density polyethylene (LLD/LD ratio) and the branched nature of the compatible polyolefinic structure. The amount of LLDPE in the formulation for this intermediate peel layer 18 is preferred as too high a percentage of LLDPE will result in too high of peel values while conversely too low a percentage of LLDPE will result in too low of peel values. When subjected to peel testing, a peel value that is too low for use is of about below 16.0 N/15 mm and a peel value that is too high is of about above 22.0 N/15 mm. A peel value that is considered too high will require an opening strength that is undesirable while a peel value that is loo low may result in poor burst performance or a consumer perception of an unsafe product.

Accordingly, when detaching a closing membrane 36 made of the composite film 10 and sealed against a sealing surface 34 of a container 40 or of a cap ring 30 connected to the container 40, the material separation takes place within the cohesively breaking intermediate layer 18, a part of which remains behind on the sealing surface 34 of the container 40 or of the cap ring 30 in the form of a uniform, visible footprint. This characteristic footprint is used for the immediate recognition of fake or manipulated packaging closures and can thus be used as a tamper-proof seal. Furthermore, it shows the final consumers that the packaging was sealed securely and hermetically upon final packing.

The metal layer 14, preferably in the form of an aluminum film or foil has a preferred thickness of 20 μm to 160 μm, and in particular 50 μm to 100 μm, and further 60 μm or 90 μm. The seal layer 20 has a preferred thickness of about 1 μm to 10 μm, and the peel layer 18 has preferred thickness of about 5 μm to 60 μm.

The metal layer 14 may consist of a foil comprising aluminum alloys usually used for closing membranes, e.g., AA 8011 and AA 8021B, or of aluminum with the usual degree of purity, e.g., AI 98.6. A soft-annealed aluminum foil is preferably used.

The protective coating 12 on an exterior side of the metal layer 14 opposite the seal layer 20 and forming the exterior surface may be comprised, for example, of a lacquer coating, a laminated plastic film or paper, or with an imprint.

The seal layer 20 is positioned adjacent the peel layer 18 and the cap ring 30 sealing surface 34, wherein the seal layer 20 is selected to adhere and secure the composite film 10 to the container 40 and forming a second exterior surface of the composite film 10 opposite the protective coating 12. The seal layer 20 comprising an LLDPE graft with maleic acid anhydride (MAH) blended with at least LDPE. As used herein, the preferred material for the seal layer 20 is ADMER™ AT3423E maleic anhydride grafted, LDPE-based adhesive resin by Mitsui Chemicals Europe GmbH.

The tie layer 16 is generally a layer selected to promote adhesion between the peel layer 18 and the metal layer 14. The tie layer may comprise ethylene acrylic acid (EAA) or as is preferred, may also comprise a blend of LLDPE graft MAH and LDPE. As used herein, the preferred EAA material of the tie layer 16 is PRIMACOR™ 3003 Copolymer by SK Global Chemical. Alternately, and preferably, the tie layer 16 may generally mirror the seal layer 20 and comprise ADMER™ AT3423E maleic anhydride grafted, LDPE-based adhesive resin by Mitsui Chemicals Europe GmbH.

Referring now specifically to FIGS. 2-4, various sectional views of the container 40 utilizing the composite film 10 of the present disclosure are depicted. The container 40 is depicted as being closed with the closing membrane 36 formed from a punch out of the composite film 10 with the seal layer 20 positioned on an interior of the container 40 and the protective coating 12 on the exterior of the container 40, The cap ring 30 is made of tinplate with a beaded edge 32 for beading onto an opening edge of the container 40. The cap ring 30 includes the sealing surface 34, protruding horizontally inwards from the beaded edge 32. The sealing surface 34 is uncoated, i.e., the sealing surface 34 has a typical surface as is common on tinplate.

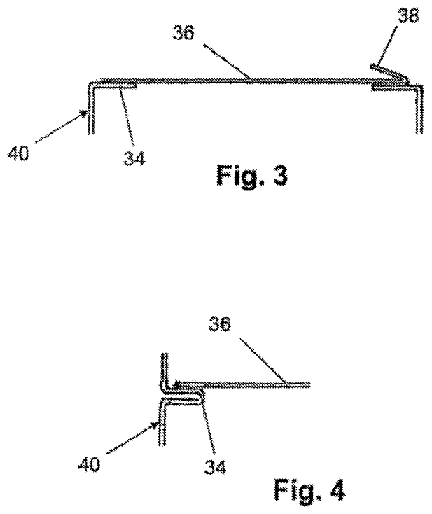

The closing membrane 36 punched out of the composite film 10 may be provided with a pull tab 38 generally indicating a location to be utilized to peel off the closing membrane 36 with the closing membrane 36 sealed onto the sealing surface 34. When peeling the closing membrane 36, the peel layer 18 breaks cohesively and a part of the peel layer 18 remains behind as a “footprint” on the sealing surface 34 and the seal layer 20. Preferably, this “footprint” is a white residue continuous around the sealing surface 34 and the sealing layer 20. Referring now to FIGS. 3-4, the sealing surface 34 is depicted as an integral part of the container 40 made of tinplate. The sealing surface 34 is formed here directly from the container 40 and is designed as a horizontally inwards directed ring flange. The outside of the container 40 and thus also the sealing surface 34 is uncoated, i.e., the sealing surface 34 has a typical tinplate surface.

When detaching the closing membrane 36 sealed against the sealing surface 34 by pulling on the pull tab 38, the material separation takes place in the interior of the intermediate portion of the peel layer 18. After the complete removal of the closing membrane 36 for the first-time opening of the container 40, a part of the intermediate peel layer 18 remains behind as a uniform coating on the sealing surface 34. This coating or footprint is used as proof that can be recognized simply and without further aid of an original packaging with tamper-proof seal.

Accordingly, the composite film 10 is particularly suitable for closing the container 40 by sealing the composite film 10 against the sealing surface 34 of the container 40 or of the cap ring 30 to be connected to the container, wherein the sealing surface 40 consists of tinplate that may subjected to passivation or lubrification.

An essential criterion of the composite film 10 according to the present disclosure is its cost-effective processing by a multilayer coextrusion consisting of the seal layer 20, the peel layer 18, and the tie layer 16, wherein these coextruded layers are preferably combined, after or during the extrusion process, with the metal layer 14 and protective coating 12 into the composite film 10.

### EXAMPLES

Tests on adhesive strength and peelability on tinplate with a lacquered protective coating 12 were carried out on composite films with the following layer structures.

Inventive Example A
a) 1.5 μm protective coating
b) 60 μm aluminum foil AA 8021B/soft-annealed
c) 4.5 μm EAA copolymer (Primacor 3003)
d) 11 μm 55% LLDPE/ 25% LDPE/talc 20% (Elite 5811/PG7008/Finntalc M05SL)
e) 1.5 μm LLDPE graft MAH (Admer AT3423)

Inventive Example B
a) 1.5 μm protective coating
b) 60 μm aluminum film AA 8021B/soft-annealed
c) 4.5 μm EAA copolymer (Primacor 3003)
d) 11 μm 60% LLDPE/20% LDPE/talc 20% (Elite 5811/PG7008/Finntalc M05SL)
e) 1.5 μm LLDPE graft MAH (Admer AT3423)

Comparative Example C
a) 1.5 μm protective coating
b) 60 μm aluminum film AA 8021B/soft-annealed
c) 4.5 μm EAA copolymer (Primacor 3003)
d) 11 μm 55% LLDPE/15% LDPE/talc 30% (Elite 5811/PG7008/Finntalc M05SL)
e) 1.5 μm EAA copolymer (Primacor 3003)

Comparative Example D
a) 1.5 μm protective coating
b) 60 μm aluminum film AA 8021B/soft-annealed
c) 4.5 μm EAA copolymer (Primacor 3003)
d) 11 μm 55% LLDPE/25% LDPE/20% inert filler (Elite 5811/PG7008/filler)
e) 1.5 μm EAA copolymer (Surlyn™1652 Ionomer)

Comparative Example E
a) 1.5 μm protective coating
b) 60 μm aluminum film AA 8021B/soft-annealed
c) 4.5 μm EAA copolymer (NUCREL™ 30707)
d) 11 μm 55% LLDPE/15% LDPE/30% talc (Elite 5811/PG7008/Finntalc M05SL)
e) 1.5 μm LDPE-MAH (Yparex® 9207)

Each of the inventive examples and the comparative examples were produced or attempted to be produced and subjected to laboratory quality testing. Comparative Example E utilizing an LDPE-MAH for the seal layer 20 was unable to be processed as processing failed during coextrusion at extrusion barrel and die temperature within a desired range of about 260-275° C.

The composite films were subjected to a peel test for determining the seal strength. The composite films were sealed under comparable sealing conditions in the form of 15-mm-wide strips against a tinplate surface. Sealing conditions were utilized according to the following criteria: inventive and comparable examples were dimensioned to a width of 15 mm and sealed to tinplate at a sealing temperature in a range of 160-220° C. at a pressure of 750 kg/150 mm² for a dwell time of 0.5 seconds.

The force needed to detach the strips from the plate support was determined as an indicator of the seal strength. Peel testing was conducted on a displaceable carriage according to the following criteria: testing was conducted after stabilization of samples at least after one hour of sealing, the pull-off angle of the strips against the tinplate surface was 180° at an opening speed of 100 mm/min. Samples were tested in parallels of three and opening peel load values and average peel load values were recorded.

All composite films with the structure according to the present disclosure showed comparable peel forces within the desired range between of about 16.0 N/15 mm and 22.0 N/15 mm. The coating remaining behind as a footprint on the tinplate was white in all inventive examples tested. Comparative Example D failed peel testing criteria in that peel values were outside of the desired range. Comparative Example E was not subjected to testing as it could not be processed.

In addition to peel testing, sealing of the composite film 10 to tinplate was tested for leakage. Leak testing consisted of storing manufactured samples at storage conditions of 50° C. for greater than three months. Comparative Example C failed this leak test.

Peel tests with tinplates with different passivations showed no differences in sealing seam strength in the usual passivations according to the codes 300, 311 and 314. Also, the aging occurring during the passivations had no effect on the sealing seam strength, i.e., the composite film reacts neutrally to the aging of the tinplate for Inventive Examples A and B.

1. A composite film for sealable and peelable lidding to be sealed against plain tinplate, the composite film comprising:
a metal layer;
a peel layer, the peel layer being a cohesively breaking intermediate layer comprising a blend of two polyolefinic polymers having branched chains and an inert filler;
a seal layer, the seal layer being a LLDPE graft MAH blended with LDPE, the seal layer contacting a container by sealing the composite film against a sealing surface of the container or of a cap ring connected to the container; and
a tie layer positioned adjacent the metal layer and the peel layer, wherein the tie layer, peel layer, and seal layer are coextruded and adhered to the metal layer.

2. The composite film according to claim 1, wherein the peel layer blend of two polyolefinic polymers having branched chains and inert filler is LLDPE/LDPE and talc.

3. The composite film according to claim 2, wherein the LLDPE/LDPE ratio is of about 55%/25%.

4. The composite film according to claim 2, wherein the LLDPE/LDPE ratio is of about 60%/20%.

5. The composite film according to claim 3, wherein the talc comprises a percentage by weight of the peel layer of about 20%.

6. The composite film according to claim 1, further comprising a protective coating.

7. The composite film according to claim 1, wherein the tie layer comprises a LLDPE graft MAH blended with LDPE.

8. The composite film according to claim 1, wherein the tie layer comprises EAA.

9. A composite film for use as a closing membrane for sealable and peelable lidding to be sealed against tinplate on a container, the closing membrane comprising:
a metal layer;
a peel layer, the peel layer being a cohesively breaking intermediate layer comprising a blend of two polyolefinic polymers having branched chains and an inert filler;
a seal layer, the seal layer being a LLDPE graft MAH blended with LDPE, the seal layer contacting the tinplate on the container by sealing the closing membrane against a sealing surface of the container or of a cap ring to be connected to the container;
a protective coating, the protective coating on an exterior surface of the metal layer; and
a tie layer positioned between the metal layer and the peel layer, wherein the tie layer, peel layer, and seal layer are coextruded and adhered to the metal layer.

10. The closing membrane according to claim 9, wherein the inert filler is talc.

11. The closing membrane according to claim 10, wherein the peel layer blend of two polyolefinic polymers having branched chains is LLDPE/LDPE and talc.

12. The closing membrane according to claim 11, wherein the LLDPE/LDPE ratio is of about 50% to 60% LLDPE and 20% to 30% LDPE.

13. The closing membrane according to claim 11, wherein the talc comprises a percentage by weight of about 20%.

14. The closing membrane according to claim 9, wherein the tie layer comprises a LLDPE graft MAH blended with LDPE.

15. The closing membrane according to claim 9, wherein the tie layer comprises EAA.

16. A container comprising a sealing surface of tinplate, the container including a closing membrane for sealable and peelable lidding to be sealed against the sealing surface, the closing membrane being a composite film comprising:
a metal layer;
a peel layer, the peel layer being a cohesively breaking intermediate layer comprising a blend of two polyolefinic polymers having branched chains and an inert filler;
a seal layer, the seal layer being a LLDPE graft MAH blended with LDPE, the seal layer contacting the tinplate of the container by sealing the closing membrane against a sealing surface of the container;
a protective coating, the protective coating on an exterior surface of the metal layer; and
a tie layer positioned between the metal layer and the peel layer, wherein the tie layer, peel layer, and seal layer are coextruded and adhered to the metal layer.

17. The closing membrane according to claim 16, wherein the peel layer blend of two polyolefinic polymers having branched chains and inert filler is LLDPE/LDPE and talc.

18. The closing membrane according to claim 17, wherein the LLDPE/LDPE ratio is of about 50% to 60% LLDPE and 20% to 30% LDPE.

19. The closing membrane according to claim 17, wherein the talc comprises a percentage by weight of about 20%.

20. The closing membrane according to claim 16, wherein the tie layer comprises a LLDPE graft MAH blended with LDPE or EAA.
